(19) United States
(12) Patent Application Publication
(10) Pub. No.: US 2014/0334193 A1
(43) Pub. Date: Nov. 13, 2014

(54) SELF-OSCILLATING LOOP BASED PIEZOELECTRIC POWER CONVERTER

(71) Applicant: NOLIAC A/S, Kvistgaard (DK)

(72) Inventors: Kaspar Sinding Meyer, Copenhagen N (DK); Michael Andreas Esbern Andersen, Helsinge (DK); Martin Schøler Rødgaard, Copenhagen N (DK); Thomas Andersen, Valby (DK)

(21) Appl. No.: 14/361,050

(22) PCT Filed: Dec. 6, 2012
(86) PCT No.: PCT/EP2012/074613

§ 371 Date: May 28, 2014

Related U.S. Application Data
(60) Provisional application No. 61/567,924, filed on Dec. 7, 2011.
(60) Provisional application No. 61/638,883, filed on Apr. 26, 2012.

(30) Foreign Application Priority Data
Dec. 7, 2011 (EP) 11192356.1

(51) Int. Cl. H02M 3/335; H02M 3/338

(52) U.S. Cl. CPC H02M 3/33592; H02M 3/3385
USPC 363/21.01

(57) ABSTRACT

The present invention relates to a piezoelectric power converter comprising an input driver electrically coupled directly to an input or primary electrode of the piezoelectric transformer without any intervening series or parallel inductor. A feedback loop is operatively coupled between an output voltage of the piezoelectric transformer and the input driver to provide a self-oscillation loop around a primary section of the piezoelectric transformer oscillating at an excitation frequency. Electrical characteristics of the feedback loop are configured to set the excitation frequency of the self-oscillation loop within a zero-voltage-switching (ZVS) operation range of the piezoelectric transformer.

The present invention relates to a piezoelectric power converter comprising an input driver electrically coupled directly to an input or primary electrode of the piezoelectric transformer without any intervening series or parallel inductor. A feedback loop is operatively coupled between an output voltage of the piezoelectric transformer and the input driver to provide a self-oscillation loop around a primary section of the piezoelectric transformer oscillating at an excitation frequency. Electrical characteristics of the feedback loop are configured to set the excitation frequency of the self-oscillation loop within a zero-voltage-switching (ZVS) operation range of the piezoelectric transformer.

### BACKGROUND OF THE INVENTION

Piezoelectric transformer based power converters have good potential to substitute traditional magnetics based power converters in numerous voltage or power converting applications such as AC/AC, AC/DC, DC/AC and DC/DC power converter applications. Piezoelectric power converters are capable of providing high isolation voltages and high power conversion efficiencies in a compact package with low EMI radiation. The piezoelectric transformer is normally operated in a narrow frequency band around its fundamental or primary resonance frequency with a matched load coupled to the output of the piezoelectric transformer. The optimum operating frequency or excitation frequency shows strong dependence on different parameter such as temperature, load, fixation and age. Hence, it is a significant challenge to maintain the excitation frequency applied to the input section of the piezoelectric transformer at the optimum frequency during operation of the power converter where the above-mentioned parameter changes. This is particularly pronounced if burst-mode modulation of the input drive signal is utilized because rapid lock-on to the intended excitation frequency is required to avoid large driver losses by intermediate time periods where the input driver fails to operate under ZVS conditions.

This problem is particularly pronounced for power converters that employ a piezoelectric transformer with native ZVS properties, i.e. with a ZVS factor larger than 100%, and exploit this property to obtain ZVS in an input driver coupled directly to the primary section of the piezoelectric transformer. In this context “directly” means without an external inductor arranged in series or parallel between the input driver and the primary section of the piezoelectric transformer. ZVS operation of the input driver, typically based on a half-bridge or full-bridge MOS transistor circuit, of piezoelectric power converters has traditionally been achieved by adding such an external inductor in series with the input driver. The external inductor ensures that the input of the piezoelectric transformer appears inductive across a relatively large frequency range such that capacitances at an output node of the input driver can be alternatingly charged and discharged in accordance with the input drive signal without inducing prohibitive power losses.

However, the external inductor occupies space, adds costs and conducts and radiates EMI in the power converter. It would therefore be advantageous to provide a power converter based on a piezoelectric transformer with native ZVS properties capable of reliable ZVS operation despite changes in operational parameters of the piezoelectric transformer such as temperature, load, fixation and age. This has been achieved in a piezoelectric power converter in accordance with the present invention by the presence of a feedback loop operatively coupled between the output signal at the output electrode of the piezoelectric transformer and the input driver to provide a self-oscillation loop around the primary section of the piezoelectric transformer. Electrical characteristics of the feedback loop are configured such that the excitation frequency of the self-oscillation loop lies within the ZVS operation range of the piezoelectric transformer.

The IEEE paper by J. Diaz et al. “A Double-Closed Loop DC/DC Converter Based On A Piezoelectric Transformer” describes a piezoelectric power converter which comprises a self-oscillating feedback loop. The input driver is, however, coupled to the input of a piezoelectric transformer via a separate external input inductor to ensure ZVS operation.

### SUMMARY OF THE INVENTION

A first aspect of the invention relates to a piezoelectric power converter comprising a piezoelectric transformer which comprises an input electrode electrically coupled to an input or primary section of the piezoelectric transformer and an output electrode electrically coupled to secondary or output section of the piezoelectric transformer to provide a transformer output voltage. An input driver is electrically coupled directly to the input electrode of the piezoelectric transformer without any intervening series or parallel inductor to supply an input drive signal to the input electrode. A feedback loop is operatively coupled between the output voltage of the piezoelectric transformer and the input driver to provide a self-oscillation loop around the primary section of the piezoelectric transformer, oscillating at an excitation frequency. Electrical characteristics of the feedback loop are configured to set the excitation frequency of the self-oscillation loop within a ZVS operation range of the piezoelectric transformer.

In accordance with the present invention, the zero-voltage-switching factor (ZVS factor) of the piezoelectric transformer is larger than 100%, preferably larger than 120%, such as larger than 150% or 200%. This means the piezoelectric transformer possesses native ZVS properties or characteristics.

The ZVS factor is determined at a matched load condition as:

$$Z V S = \frac{( {k}_{{eff}_{- S}}^{- 2} ) - 1}{( {k}_{eff\_p}^{- 2} ) - 1} 0.882 ;$$

k_{eff}_{_{—}}_{P}, being a primary side effective electromechanical coupling factor of the piezoelectric transformer,
k_{eff}_{_{—}}_{S}, being a secondary piezoelectric transformer effective electromechanical coupling factor, in which:

$${k}_{eff\_P} = \sqrt{1 = \frac{{f}_{res\_p}^{2}}{{f}_{anti \text{-} res\_p}^{2}}}$$

$${k}_{eff\_S} = \sqrt{1 - \frac{{f}_{res\_s}^{2}}{{f}_{anti \text{-} res\_s}^{2}}}$$

fᵣₑₛ_{_{—}}ₚ=resonance frequency and frequency of a minimum magnitude of an impedance function at the input electrodes of the piezoelectric transformer with shorted output electrodes,
fₐₙₜᵢ₋ᵣₑₛ_{_{—}}ₚ=anti-resonance frequency and frequency of a maximum magnitude of the impedance function at the input electrodes of the piezoelectric transformer with shorted output electrodes,
fᵣₑₛ_{_{—}}ₛ=resonance frequency and frequency of a minimum magnitude of the impedance function at the output electrodes of the piezoelectric transformer with shorted input electrodes, fₐₙₜᵢ₋ᵣₑₛ_{_{—}}ₛ=anti-resonance frequency and frequency of a maximum magnitude of the impedance function at the output electrodes of the piezoelectric transformer with shorted input electrodes.

A number of highly useful piezoelectric transformers suitable for application in the present piezoelectric power converters with high power conversion efficiencies and native ZVS properties are disclosed in the applicant's co-pending European patent application No. 11176929.5.

The self-oscillating feedback loop around the native ZVS capable piezoelectric transformer with direct electrical coupling from the input driver to the input electrode without any intervening series or parallel inductor both dispenses with the external inductor. Instead ZVS operation of the input driver is ensured by the inductive behaviour of the piezoelectric transformer within the ZVS operation range of the piezoelectric transformer. Hence, the commonly employed external inductor, which occupies space, adds costs, conducts and radiates EMI as explained above, is avoided. In the direct coupling from the input driver to the input electrode, the inductance of the ordinary external inductor is replaced by the mechanical equivalent inductance already embedded in the vibratory mass of the piezoelectric transformer due to its native ZVS properties. Hence, the radiated EMI from the commonly employed external inductor is largely eliminated. Furthermore, because the ordinary external inductor often employs a ferrite core material the external inductor becomes prone to magnetic saturation from large static or dynamic magnetic fields for example in applications such as MRI scanners, power plants etc. Magnetic saturation of the ferrite core material may cause the piezoelectric power converter to malfunction. This problem is also removed by the elimination of the ordinary external inductor. The self-oscillating feedback loop furthermore provides a mechanism for maintaining the optimum excitation frequency despite environmental parameters strong influence on the electrical characteristics of the piezoelectric transformer. These environmental parameters comprise operation temperature, load, fixation and age of the piezoelectric transformer.

The skilled person will understand that a parasitic wiring or cabling inductance naturally will be associated with the direct electrical coupling between an output of the input driver and the input electrode despite the lack of a separate input inductor. The power converter is preferably designed such that the wiring inductance from the output of the input driver to the input electrode of the piezoelectric transformer is smaller than 500 μH, preferably smaller than 100 μH, even more preferably smaller than 10 μH.

The electrical characteristics of the feedback loop are preferably configured to set the excitation frequency within the ZVS operation range of the piezoelectric transformer. The bandwidth of the ZVS operation range is typically narrow and located slightly above a fundamental resonance frequency of the piezoelectric transformer depending on specific characteristics of a design of the piezoelectric transformer. The bandwidth of the ZVS operation range of piezoelectric transformers may vary widely between different transformer topologies, modes of operation and physical dimensions. In some embodiments, the piezoelectric transformer is designed or configured with a bandwidth of the ZVS operation which lies between 1% and 5% of a fundamental or primary resonance frequency of the piezoelectric transformer. In a number of useful embodiments, the electrical characteristics of the feedback loop are configured to set the excitation frequency to a frequency between 75 kHz and 10 MHz such as between 200 kHz and 20 MHz.

The phase-shift around the feedback loop must be an integer multiple of 360 degrees where the distribution of individual phase shifts between components and circuits of the feedback loop can be effected in numerous ways. The self-oscillation provided by the feedback loop ensures that the excitation frequency automatically tracks changing characteristics of the piezoelectric transformer and electronic circuitry of the input side of the power converter. This effect is particularly pronounced according to a preferred embodiment of the power converter wherein the feedback loop comprises a phase shifting circuit for example a frequency selective filter such as a high-pass, band-pass or a low-pass filter. According to this preferred embodiment, a slope or derivative of a phase response of a transfer function of the piezoelectric transformer is steeper than a slope or derivative of a phase response of the high-pass, band-pass or the low-pass filter within the ZVS operation range of the piezoelectric transformer. The high-pass, band-pass or the low-pass filter is preferably a low order filter such as a first or second order filter which exhibits a relative gentle slope of the phase response. In this way, the slope of the phase response of the piezoelectric transformer becomes much steeper than the slope of the phase response of the frequency selective filter. The predetermined excitation frequency will as a consequence become significantly more sensitive to changes to the frequency response characteristic of the piezoelectric transformer than to changes of the response of the frequency selective filter. For this reason the self-oscillating feedback loop automatically maintains the predetermined excitation frequency at an optimum frequency or within an optimum frequency band.

According to one embodiment, the feedback loop comprises a cascade of a phase shifter and a comparator. The phase shifter is coupled for receipt of the feedback signal and configured to apply a predetermined phase shift to the feedback signal to provide a phase shifted feedback signal. The comparator is coupled for receipt of the phase shifted feedback signal to generate a square-wave feedback signal at a comparator output. The square-wave feedback signal is coupled to an input of the input driver so as to close the feedback loop.

The respective phase-shifts induced to the feedback signal by the phase shifter and the comparator may be adjusted in various ways to achieve a certain total phase shift complementing other signal phase shifts around the self-oscillating feedback loop. In one embodiment, the comparator comprises an inverting zero-crossing detector to provide square-wave feedback signal indicating zero-crossings of the phase-shifted feedback signal. In this manner, the inversion introduces a phase shift of at least 180 degrees in the self-oscillating feedback loop. The phase shifter may comprise a frequency selective filter and/or a time delay. The frequency selective filter may comprise a high-pass, band-pass or a low-pass filter with an appropriately tailored phase response. In the alternative, or in addition, the phase shifter may comprise an all-pass type of filter inducing a predetermined phase shift to the self-oscillating feedback loop without any frequency response filtration of the feedback signal.

The feedback signal to the feedback loop, which is operatively coupled between the output voltage of the piezoelectric transformer and the input driver, may be derived in numerous ways from the output voltage of the piezoelectric transformer. According to one embodiment, the feedback signal of the feedback loop is derived from the transformer output signal at the output electrode of the piezoelectric transformer. In this embodiment the feedback signal is derived directly from the existing output electrode(s) which also supplies power to a DC or AC output voltage node or terminal of the power converter. This embodiment is simple to implement because it uses existing signals and electrodes of the power convertor to provide the feedback signal. However, the feedback signal will be galvanically coupled to the output section of the piezoelectric transformer unless expensive and bulky precautions are taken such as the insertion of isolating optical couplers in the feedback loop. The output section of the piezoelectric transformer may have a very high voltage level for example at mains voltage (110 V to 230 V) or even higher voltages above 1 kV.

In an advantageous embodiment, the potential safety and regulatory problems caused by the galvanic coupling between the output section and output electrode and the input driver or input side by the feedback signal are avoided by adding a separate feedback output electrode to the output section or sections of the piezoelectric transformer. According to this embodiment, the feedback signal of the feedback loop is derived from a feedback output signal at the feedback output electrode arranged in one or more separate layer(s) of the output section of the piezoelectric transformer to galvanically isolate the feedback output electrode from the output electrode by the electrically insulating piezoceramic material of the transformer. The piezoelectric transformer may generally be configured such that a voltage gain, at the excitation frequency, from the input electrode to the output electrode is larger, substantially equal to, or smaller than a voltage gain from the input electrode to the feedback output electrode. In one embodiment, the voltage gain from the input electrode to the output electrode is between 2 and 50 times larger than the voltage gain from the input electrode to the feedback output electrode. This embodiment is particularly helpful if the output section of the piezoelectric transformer operates at a very high voltage level such as at the mains voltage (110 V to 230 V) or higher as mentioned above. The level of the feedback output signal can be stepped down to a manageable level for example between 5 and 10 V such that galvanic isolation and a voltage level that is compatible with a voltage range of the electronic circuitry of the feedback loop is simultaneously provided. According to another embodiment, the voltage gain from the input electrode to the output electrode is between 2 and 50 times smaller than the voltage gain from the input electrode to the feedback output electrode. This embodiment is particularly helpful if the output section of the piezoelectric transformer operates at a relatively low voltage level such as CPU power supplies (e.g. 0.2 V to 5V DC). The level of the feedback output signal is stepped down to a manageable level for example between 5 and 10 V so as to simultaneously provide galvanic isolation and a voltage level that is compatible with a voltage range of the electronic circuitry of the feedback loop.

In many applications, a power delivery requirement of the feedback output electrode will be substantially insignificant in comparison to the required load power at/from the output electrode. It may therefore be advantageous to design or construct the piezoelectric transformer such a volume of the separate layer of the output section enclosing the feedback output electrode is smaller than a volume of layers of the output section enclosing the output electrodes, as the power output capability of the output electrode is proportional to the associated layer volume.

The skilled person will understand that separate feedback output electrode can be highly useful for galvanic isolation, and other purposes, in piezoelectric power converters which comprise the ordinary series or parallel inductor coupled between the input driver and the input electrode.

The feedback signal to the feedback loop can also be derived in an indirect manner from the input side of the piezoelectric power converter according to another preferred embodiment of the invention. Due to the lack of the ordinary series or parallel inductor between the input driver and the input electrode, the transformer resonance current cannot be directly monitored or detected at the input side of the power converter. However, the transformer resonance current can be estimated or derived from the input drive signal and a transformer input current. In this embodiment, the feedback signal of the feedback loop is derived by a transformer resonance current estimator from a combination of the input drive signal and the transformer input current running in the primary section of the piezoelectric transformer. This methodology may be applied to build or estimate a continuous transformer resonance current signal. This is preferably accomplished by differentiating the input drive voltage signal before adding/subtracting this signal from the transformer input current signal since the slope of rising and falling edges of the input drive signal indicates the transformer resonance current during time intervals of the input drive signal where the input driver is off. Consequently, the resonance current estimator preferably comprises:
a first order differentiator coupled to the input drive signal to derive a first order derivative signal of the input drive signal,
a current sensor, coupled in series with the primary section of the piezoelectric transformer, to supply a sensor signal representative of the transformer input current; and
a subtractor configured to generate the feedback signal based on a difference between the first order derivative signal and the sensor signal.

The input current sensor may comprise a resistance arranged in-between a ground connection of the input driver and a ground connection of the piezoelectric transformer to supply a sensor voltage representative of the transformer input current. The first order differentiator may comprise a first order high-pass filter having an input coupled to the input drive signal and an output supplying the first order derivative signal. A high-pass corner frequency of the first order high-pass filter is preferably larger than a fundamental resonance frequency of the piezoelectric transformer such as at least two times larger or preferably more than 10 times larger. In this manner, it is ensured that the high-pass corner frequency of the first order high-pass filter lies above the excitation frequency because the latter frequency typically is situated proximately to the fundamental resonance frequency of the piezoelectric transformer where the ZVS operation range is located, ensuring that the high-pass filter operates as a true differentiator at the excitation frequency. The subtractor may be implemented in various ways. One embodiment of the subtractor comprises a differential amplifier having a first differential input coupled to the first order derivative signal and the second differential input coupled to the sensor signal. The differential amplifier preferably comprises an operational amplifier either as a separate standard component or as sub-circuit of an Application Specific Integrated Circuit (ASIC) having integrated thereon other types of electronic circuitry of the present piezoelectric power converter.

According to another preferred embodiment of the invention, the piezoelectric power converter comprises a bi-directional switching circuit for reverse power transfer from the load at the output or secondary side of the power converter back to the input side. According to this embodiment, the piezoelectric power converter comprises:
a bi-directional switching circuit coupled between the output electrode and an output voltage of the power converter,
a controller adapted to control first and second states of the bi-directional switching circuit based on the input drive signal or the transformer output voltage such that:
in a first state, forward current is conducted from the output electrode to the output voltage through the bi-directional switching circuit during a first period of a cycle time of the transformer output signal to charge the output voltage,
in a second state, reverse current is conducted from the output voltage to the output electrode through the bi-directional switching circuit during a second period of the cycle time of the transformer output signal to discharge the output voltage and return power to the primary section of the piezoelectric transformer.

The presence of the second state wherein reverse current is conducted from the output voltage through the bi-directional switching circuit to the output electrode allows effective output voltage regulation without sacrificing efficiency of the piezoelectric based power converter. This is because the reverse power is returned to the primary section or side of the piezoelectric transformer. The transmission of reverse current during the second period of the cycle time exploits he inherent bi-directional power transfer property of piezoelectric transformers such that power is transferred in opposite direction to the ordinary direction, i.e. forward direction, of power flow in the power converter. Surplus power at the output voltage is transmitted back to the input power source such as a DC supply voltage supplying power to the input driver. According to a preferred embodiment of the invention, the controller is in the second state further configured to control the switching circuit such that both forward current and reverse current is conducted during a single cycle of the transformer output signal. In this embodiment the forward current is conducted during the first period of the cycle time and reverse current is conducted during the second period of the same cycle of the transformer output signal. The second period may have a length corresponding to about one-half or less than the cycle time cycle time of the transformer output signal. The skilled person will appreciate that the degree of charge or discharge of the output voltage may be controlled in a step-wise or substantially continuous manner by a corresponding control of the relative length between the first and second periods of the same cycle of the transformer output signal. In this manner, the controller may provide effective output voltage control through adjustment of the length of the second period of the cycle time. Accordingly, by appropriately balancing the length of the first period of the cycle time relative to the second period of the same cycle, the bi-directional piezoelectric power converter may be adapted to transfer net power to the output voltage or to a load coupled thereto, transfer substantially zero power to the output voltage or transfer a negative power to the output voltage. The skilled person will understand that if the controller sets the length of the second period of the cycle time to zero, the bi-directional piezoelectric power converter conveniently transits from the second state to the first state wherein the bi-directional switching circuit conducts solely forward current so as to charge the output voltage during the first periods of the cycle times. This leads to an increasing level of output voltage e.g. the output voltage becomes more positive or more negative depending on the polarity configuration of the bi-directional switching circuit. In general, the controller may be adapted to terminate the second period of the cycle time, i.e. terminating the reverse conduction of current through the switching circuit, synchronously or asynchronously to the input drive signal or the transformer output signal. The controller preferably comprises an adjustable time delay circuit providing an adjustable duration of the second period of the cycle time of the transformer output signal such that the amount of reverse power can be controlled. The controller is preferably configured to derive a synchronous state control signal from the input drive signal and apply the synchronous state control signal through the adjustable time delay circuit to a switch control terminal of the second controllable semiconductor switch and/or a switch control terminal of the first controllable semiconductor switch to control respective states of the first and second controllable semiconductor switches. In this manner, the switching circuit is responsive to the synchronous state control signal indicating the termination of the second period of the cycle time. The skilled person will understand that the synchronous state control signal may be derived directly or indirectly from the input drive signal. Indirectly if the synchronous state control signal is derived from another signal in the power converter that is synchronous to the input drive signal such as the transformer output signal. In one such embodiment, the synchronous state control signal is derived from a zero-crossing detector embedded in a self-oscillating feedback loop enclosing input section of the piezoelectric transformer.

The operation of the power converter during the second state of the bi-directional switching circuit where reverse power is transmitted can be improved in accordance with one embodiment of the invention. When reverse power is transmitted through the power converter the excitation frequency set by the feedback loop decreases. This leads to an increase of the transformer resonance current level and may be counteracted by adjustment of a time delay in the self-oscillating feedback loop. In one embodiment, the feedback loop comprises an adjustable time delay coupled in cascade with the phase shifter and the comparator to adjust the excitation frequency of the feedback loop. This embodiment may further comprise a current detector configured to determine the level of the transformer resonance current and a current limiter adapted to adjust the time delay of the adjustable time delay circuit to limit the transformer resonance current. In this manner an optimal operating point or excitation frequency of the feedback loop can be maintained during both forward power transmission and reverse power transmission of the bi-directional piezoelectric power converter.

The feedback loop may in certain situations be unable to induce a reliable start of the self-oscillation action due to amongst other factors the non-linear behaviour of the input driver which makes the latter insensitive to low level fluctuations of its input voltage. This may for example the situation if a bandwidth of the phase shifter is so low that noise signal components within the feedback loop are small. Consequently, an advantageous embodiment of the invention comprises a start-up circuit configured to inject a transient signal into the feedback loop at power-up of the power converter to initiate oscillation at the excitation frequency in the feedback loop. The skilled person will understand that the start-up circuit could be configured in a numerous ways to generate the desired transient signal. The transient signal could comprise a one or more signal pulses of predetermined waveform shape and duration. In another embodiment, the start-up circuit comprises an oscillator coupled into the feedback loop. The oscillator may be configured to generate an essentially continuous transient signal that is removed from the feedback loop by a suitable mechanism once self-oscillation has started. This may for example be controlled by an output impedance of the oscillator which is so large that the continuous transient signal is suppressed or eliminated once self-oscillation is initiated.

### BRIEF DESCRIPTION OF THE DRAWINGS

Preferred embodiments of the invention will be described in more detail in connection with the appended drawings, in which:

FIG. 1 is a schematic block diagram of a piezoelectric power converter comprising a self-oscillating loop in accordance with a first embodiment of the invention,

FIG. 2a) is an electrical equivalent circuit of a piezoelectric transformer coupled to an input driver of a piezoelectric power converter in accordance with a first embodiment of the invention,

FIG. 2b) shown input drive voltage and input current waveforms of the piezoelectric transformer in accordance with the first embodiment of the invention,

FIG. 3 a detailed schematic block diagram of a transformer resonance current estimator coupled to an input section of a piezoelectric transformer of the piezoelectric power converter in accordance with the first embodiment of the invention,

FIG. 4 is a schematic block diagram of a piezoelectric power converter comprising a self-oscillating loop in accordance with a second embodiment of the invention,

FIG. 5 is a detailed schematic block diagram of a transformer output voltage detection circuit coupled to an output section of the piezoelectric transformer of the piezoelectric power converter in accordance with the second embodiment of the invention,

FIG. 6 is a simplified schematic block diagram of a piezoelectric power converter comprising a self-oscillating loop based on a separate feedback electrode in accordance with a third embodiment of the invention,

FIG. 7 is a simplified electrical equivalent circuit of the piezoelectric transformer of the piezoelectric power converter in accordance with the third embodiment of the invention; and

FIG. 8 is a schematic block diagram of a piezoelectric power converter comprising a self-oscillating loop and a bi-directional switching circuit for reverse power transfer in accordance with a fourth embodiment of the invention.

### DETAILED DESCRIPTION OF PREFERRED EMBODIMENTS

The below appended detailed description of embodiments of the present invention comprises various types of self-oscillating loops for DC-DC voltage boost or buck power conversion. However, the skilled person will understand that the below described embodiments are highly useful for other types of power conversion applications such as AC-AC, AC-DC, DC-AC and DC-DC conversion, in particular power conversion requiring high efficiency and compact dimensions by ZVS operation of the input driver without an external inductor at the input electrode.

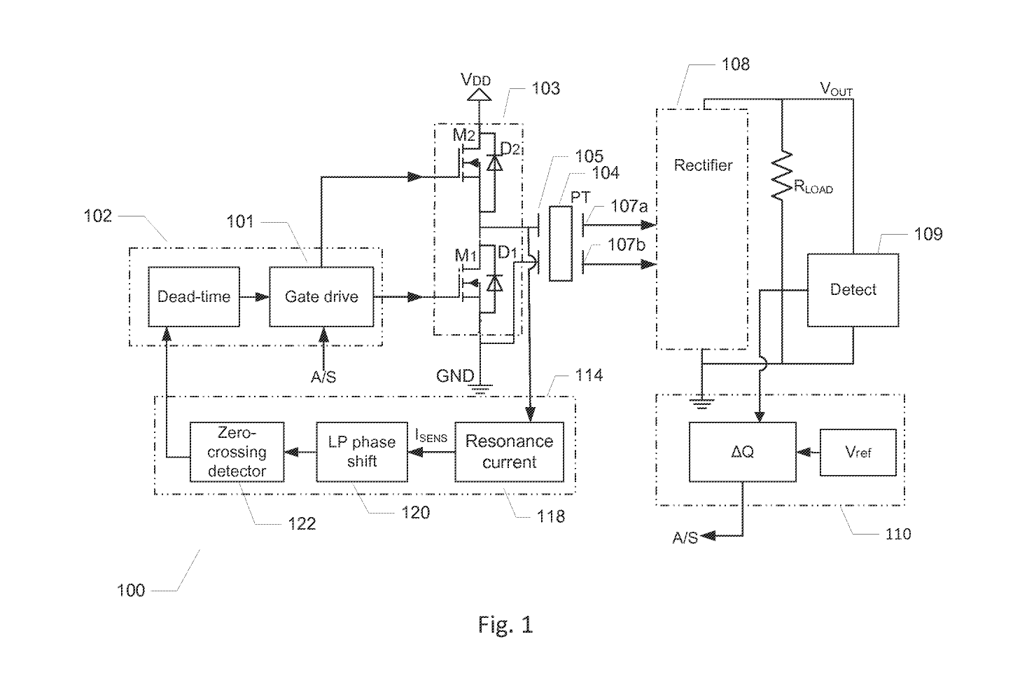

FIG. 1 shows a schematic block diagram of a piezoelectric power converter 100 in accordance with a first embodiment of the invention. The bi-directional piezoelectric power converter 100 comprises a piezoelectric transformer, PT, 104. The piezoelectric transformer, PT, 104 has a first input electrode 105 electrically coupled to an input or primary section of the piezoelectric transformer 104, coupled to the input driver 103 of the piezoelectric power converter and a second input electrode connected to ground, GND. A first output electrode 107a and second output electrode 107b of the piezoelectric transformer 104 are electrically coupled to secondary or output section of the piezoelectric transformer 104 to provide a differential transformer output voltage or signal to a rectification circuit 108. The rectification circuit 108 may comprise a half or full wave rectifier and an output capacitor to provide smoothed DC voltage at the output node or terminal V_{OUT}.

The piezoelectric power converter 100 additionally comprises an input driver 103 electrically coupled directly to the input electrode 105 without any intervening inductor so as to apply an input drive signal to the input or primary section of the transformer 104. A driver control circuit 102 generates appropriately timed gate control signals for NMOS transistors M₂ and M₁ of the input driver 103. The input drive signal has a predetermined excitation frequency determined by parameters of a self-oscillating feedback loop operatively coupled between the output voltage of the piezoelectric transformer at output electrodes 107 and 107b and the input driver 103.

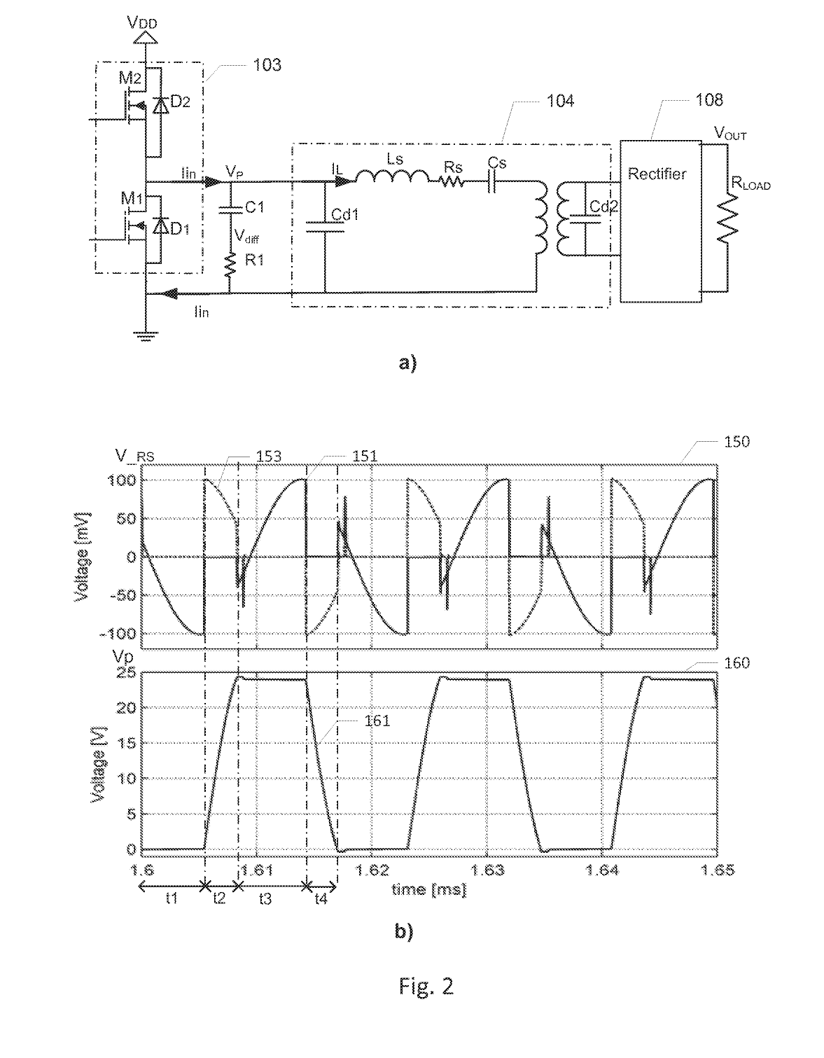

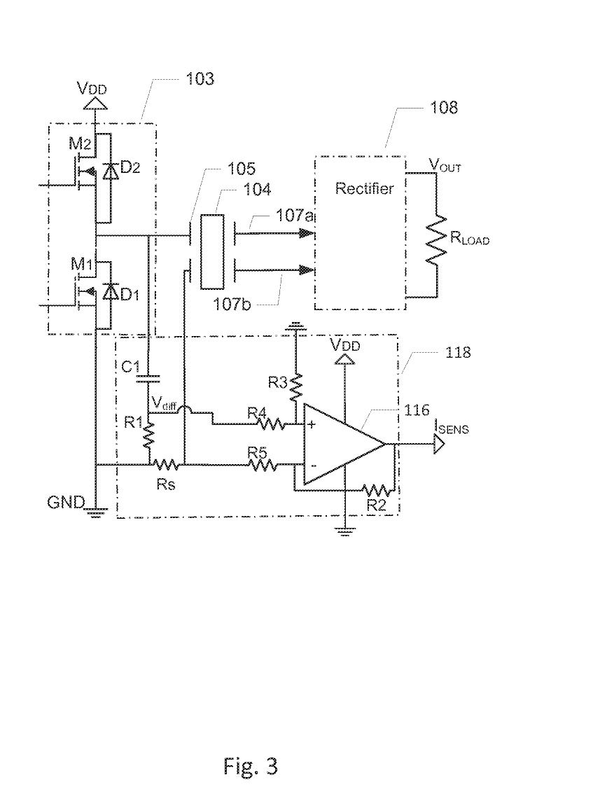

In the present embodiment, the transformer output voltage is detected indirectly by estimating the transformer resonance current from a combination of the input drive signal supplied at input terminal 105 and a transformer input current running in the primary section of the piezoelectric transformer as explained in detail below in connection with FIGS. 2 and 3 showing schematic and signal waveforms of a resonance current detector 118 performing this task. Electrical characteristics of the self-oscillating feedback are configured to set the excitation frequency of the self-oscillation loop within a ZVS operation range of the piezoelectric transformer. The self-oscillating feedback loop comprises a feedback leg 114 coupling a resonance current indicative signal I_{SENSE} which is proportional of the transformer output voltage back to the input driver through a cascade of low-pass filter 120 and a zero-crossing detector 122 such that the loop is closed around the input section of the transformer. The phase-shift around the self-oscillation loop feedback loop or simply feedback loop must be an integer multiple of 360 degree and the respective phase-shifts induced by the resonance current detector 118, the low-pass filter 120 and a zero-crossing detector 122 adjusted in an appropriate manner to achieve this goal.

It is furthermore desired to maintain a phase shift of approximately 55 degrees between the input drive signal and the transformer resonance current as set by the resonance current detector 118 because this phase difference ensures that the excitation frequency is located within a narrow frequency band above the fundamental resonance frequency of the piezoelectric transformer 104 where native ZVS operation is enabled. Within this narrow frequency band of ZVS operation, the piezoelectric transformer 104 exhibits the above-described ZVS factor larger than 100% such as larger than 120% and appears to possess inductive input impedance as seen from the output of the input driver 103. To reach the desired phase shift around the feedback loop on the integer multiple of 360 degrees, the zero-crossing detector 122 may be inverting to induce a further 180 degrees phase shift and a combined time delay of the input driver 103 and the driver control circuit 102 may amount to about 40 degrees of phase shift at the predetermined excitation frequency. These phase shifts add up to about 275 degrees such that the electrical characteristics of the low-pass filter 120 are designed to induce a phase shift of 75 degrees at the predetermined excitation frequency. This can be achieved by selecting an appropriate cut-off frequency and order of the low-pass filter 120. The skilled person will understand that many other distributions of phase shifts between the circuits of the feedback leg 114 are possible. In one embodiment, the resonance current detector 118 is inverting to add another 180 degrees of phase shift. The low-pass filter 120 could be replaced by a band-pass filter or a pure time delay designed to provide the desired amount of phase shift.

At the secondary side of the PT 104, a rectifier or rectification circuit 108 is electrically coupled between a differential transformer output signal generated at the output electrodes 107a and 107b coupled to respective output sections of the PT 104. The rectification circuit 108 may be configured to provide half-wave or full-wave rectification of the transformer output signal supplied between the positive output electrode 107a and the negative, or opposite phase, output electrode 107b. The rectification circuit 108 preferably comprise a rectifier capacitor of appropriate capacitance (not shown) configured to generate a positive or negative DC output voltage V_{OUT} across the load resistance R_{LOAD} of the power converter 100. The load may of course comprise a capacitive and/or inductive component in addition to the depicted load resistor R_{LOAD}. During operation of the piezoelectric power converter 100 the level of the DC output voltage V_{OUT} is adjusted or controlled by a control mechanism or loop. The control loop comprises a DC output voltage detection or monitoring circuit 109 which supplies a signal to the output voltage control circuit 110 indicating an instantaneous level of the DC output voltage. A charge control circuit ΔQ compares the measured instantaneous level of the DC output voltage with a reference voltage V_{ref} which for example represents a desired or target DC output voltage of the power converter at V_{OUT}. The charge control circuit determines whether the level of the current DC output voltage is to increase or decrease based on the result of the comparison. The output voltage control circuit 110 generates an Active/Shutdown (A/S) control signal for the gate driver 101 such that the gate driver is disabled if the instantaneous level of the DC output voltage is larger than the reference voltage V_{ref}. If the instantaneous level of the DC output voltage is smaller than the reference voltage V_{ref} the gate driver is enabled and in this burst-mode manner power or energy is transferred to the converter output voltage through the rectification circuit 108.

FIG. 2a) is an electrical equivalent circuit of the piezoelectric transformer 104 coupled directly to the input driver 103 and to the rectification circuit 108 of the piezoelectric power converter 100 depicted on FIG. 1. As previously mentioned, the transformer output voltage across the first and second output electrodes 107a and 107b is detected indirectly by estimating the transformer resonance current I_{L} from a combination of the input drive signal Vₚ at input terminal 105 and the transformer input current Iᵢₙ running through the primary section of the piezoelectric transformer 104. Since the input driver 103 is directly coupled to the input section of the piezoelectric transformer 104 without any external series or parallel inductor, the transformer resonance current cannot be measured through the external series or parallel inductor. The present embodiment of the invention utilizes a resonance current estimator instead to determine or estimate the transformer resonance current indirectly and derive a continuous resonance current signal I_{SENSE} which is supplied to the feedback loop to provide a feedback signal representative of the transformer resonance current. The estimated transformer resonance current is accordingly also representative of the transformer output voltage at the first and second output electrodes 107a and 107b. The resonance current estimator comprises a first order differentiator comprising series coupled capacitor C1 and resistor R1 coupled to the input drive signal Vₚ. The mid-point voltage V_{diff} at the coupling node between the series coupled capacitor C1 and resistor R1 supplies a first order derivative signal of the input drive signal Vₚ because a high-pass corner frequency of the first order differentiator is much larger than the fundamental resonance frequency of the piezoelectric transformer 104 such as at least two times larger e.g. 10 times larger.

The transformer input current Iᵢₙ is detected in the resonance current detector 118 depicted in a detailed schematic diagram on FIG. 3 by a small series resistor R_{S} acting as a current sensor coupled in series with the primary section of the piezoelectric transformer 104. The series resistor R_{S} is coupled in a ground line or wire between the ground connection of the primary side of the piezoelectric transformer 104 and the ground connection of the first order differentiator. Hence, a voltage across the series resistor R_{S} represents, i.e. is proportional to, the transformer input current Iᵢₙ. The first order derivative signal V_{diff} and the transformer input current signal are supplied to respective inputs of a differential amplifier of the resonance current detector 118. The differential amplifier comprises an operational amplifier 116 and gain setting resistors R2, R3, R4 and R5 configured such that the gain from each of the inputs can be separately adjusted. The gain from V_{diff} to the resonance current signal I_{SENSE} is adjustable by R4 and R3 and the gain from the transformer input Iᵢₙ current signal is adjustable by R5 and R2 such that convenient scaling between V_{diff} and Iᵢₙ is provided. Furthermore, the scaling can also be provided by the selection of R_{S}, R1 and C1. The function of the resonance current detector 118 is explained by reference to the measured input drive voltage waveform 161 at the lower graph 160 and the transformer input current waveform 151 depicted on the upper graph 150 of FIG. 2b). The transformer input current waveform 151 is represented by the measured voltage across the series resistor R_{S} as explained above. The transformer input current Iᵢₙ and the voltage across the series resistor R_{S} are zero during time periods where the input driver is off, i.e. its dead-time intervals, indicated below the graph 160 as t2 and t4, because the output of the input driver at node V_{P} is charged by the resonance current of the piezoelectric transformer itself. However, the true transformer resonance current I_{L} is unavailable outside the physical structure of the piezoelectric transformer 104 because a large portion of the resonance current is conducted through the transformer input capacitance represented by parallel capacitor Cd1 of the equivalent diagram of FIG. 2a). However, by differentiating the up and down going transitions of the measured input drive voltage waveform 161 during the dead-time intervals t2 and t4, a scaled representation of the true transformer resonance current I_{L} is determined. Since the first order derivative signal V_{diff} of the measured input drive voltage waveform 161 is approximately zero (no slope) during on-periods of the input driver 103 as indicated by time periods t1 and t3 the first order derivative does not make any significant contribution to the resonance current signal I_{SENSE} during the latter time periods. During time periods t1 and t3 where the input driver 103 is active and conducting, the transformer resonance current flows through series resistor R_{S} and therefore generates a proportional sensed voltage which contributes to the resonance current signal I_{SENSE}. This is indicated by the approximate sine shape of the transformer input current waveform 151 during time periods t1 and t3. Hence, the resonance current detector 118 generates a continuous loop feedback signal in form of the resonance current signal I_{SENSE} by combining the first order derivative signal V_{diff} 153 derived from the input voltage V_{P} 161 and the transformer input current Iᵢₙ measured across the sense/series resistor R_{S} 151.

Since the resonance current signal I_{SENSE} for the feedback loop is generated from the input section of the piezoelectric transformer 104, the feedback signal is galvanic insulated from the output section of the piezoelectric transformer 104. Hence, if the output section supplies high voltage signals because of the amplification characteristics of the piezoelectric transformer 104, the primary section is isolated from the high voltages enhancing safety and helps the power converter in complying with high voltage regulatory requirements.

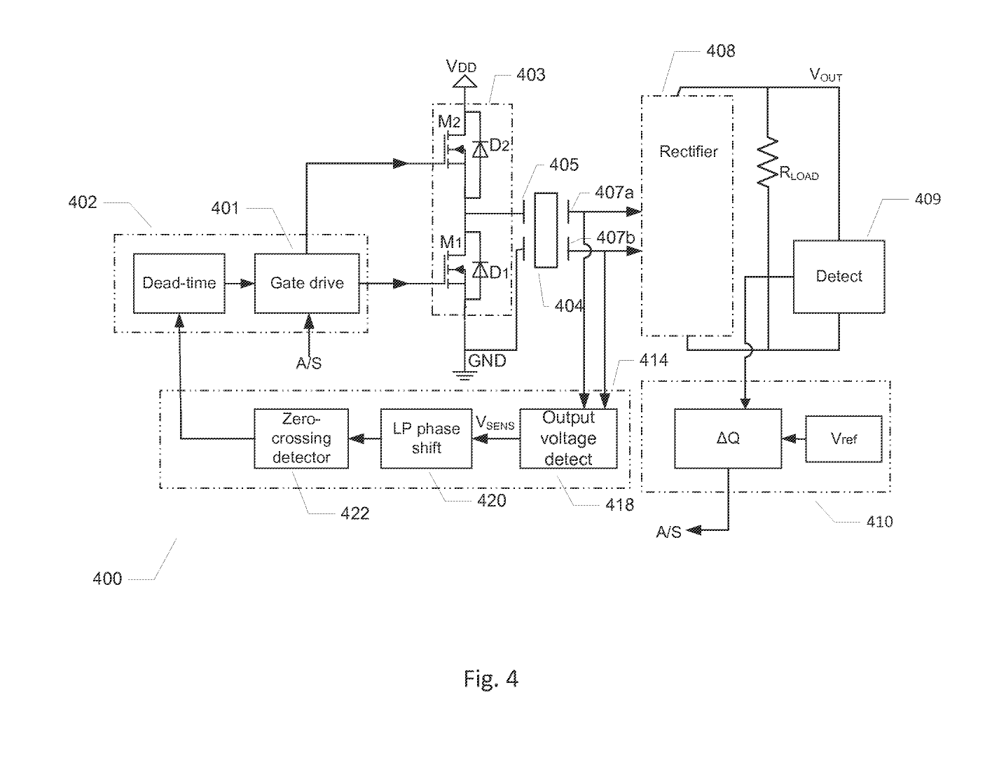

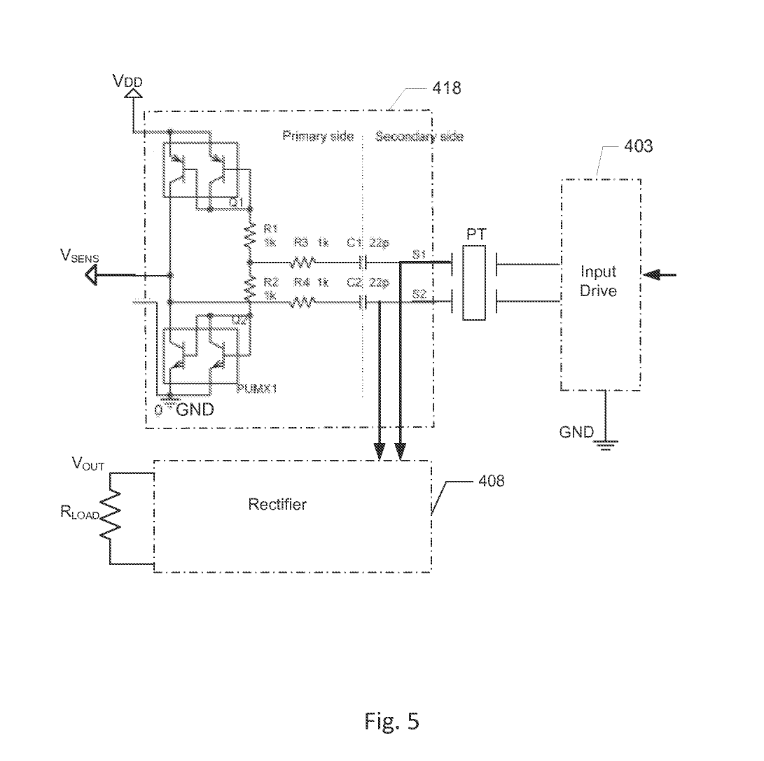

FIG. 4 is a schematic block diagram of a piezoelectric power converter 400 comprising a self-oscillating loop in accordance with a second embodiment of the invention. The piezoelectric power converter 400 shares a large number of electrical characteristics and features with the above described first embodiment of the power converter and therefore have corresponding features been provided with corresponding reference numerals to ease comparison. However, the way the feedback signal for the feedback leg 414 is derived from the piezoelectric transformer 404 differs between the present embodiment and the first embodiment. In the present embodiment, a differential transformer output voltage or signal for the feedback loop is derived from a first output electrode 407a and second output electrode 407b of the piezoelectric transformer 404. The first and second output electrodes 407a, 407b are in addition electrically coupled to respective secondary or output sections of the piezoelectric transformer 404 to provide the differential transformer output voltage to a rectification circuit 408. The rectification circuit 408 may comprise a half or full wave rectifier and an output capacitor to provide smoothed DC voltage at the output node or terminal V_{OUT}. An output voltage detection circuit 418 receives the differential transformer output voltage and generates a single-ended or differential sense signal, V_{SENS} which is transmitted to a low-pass filter 420 with similar characteristics to the low-pass filter of the first embodiment discussed above. Since, a potentially high transformer output voltage is fed back to the input section or primary side of the converter 400 there is not any galvanic isolation between the output side/voltage and the input side. However, in one preferred embodiment, the output voltage detection circuit 418 comprises a pair of small series capacitors that at least breaks any DC current path between the output side/voltage and the input side as described below in connection with FIG. 5. The skilled person will notice that the output voltage detection circuit 418 can be made less complex in the present embodiment compared to the resonance current detector 118 coupled to the primary transformer side of the piezoelectric transformer 104 in the first embodiment because a continuous transformer output voltage signal representing the transformer resonance current is directly available for the self-oscillating feedback loop in the present embodiment of the converter.

FIG. 5 is a detailed schematic block diagram of the transformer output voltage detection circuit 418 coupled to the output section of the piezoelectric transformer 404 (PT) of the piezoelectric power converter schematically depicted on FIG. 4. The rectifier 408 and the input driver 403 are also schematically indicated to ease comparison. The transformer output voltage detection circuit 418 comprises a first pF sized series capacitor C1 coupled in series with the first output electrode 407a (S1) and a second pF sized series capacitor C1 coupled in series with the second output electrode 407b (S2). A network of resistors R3 and R1 are configured to couple one phase of the transformer output signal from the series capacitor C1 to a matched pair of current mirror coupled transistors Q1. A corresponding coupling arrangement is connected to the other series capacitor C2. In effect, the single-ended feedback signal V_{SENS} is derived from the differential transformer output voltage. The feedback signal V_{SENS} is essentially a square wave signal in phase with the differential transformer output voltage. This feedback signal V_{SENS} is subsequently applied to the feedback leg 414 and phased shifted trough the low-pass filter 420 with similar characteristics to the low-pass filter of the first embodiment discussed above.

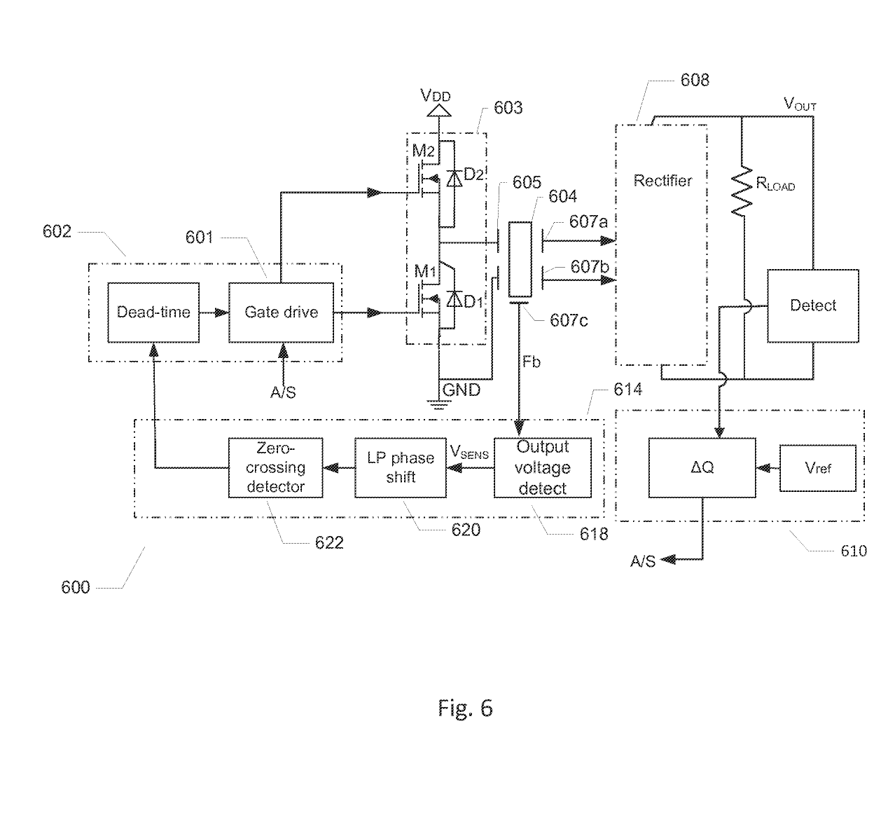

FIG. 6 is a simplified schematic block diagram of a piezoelectric power converter 600 comprising a self-oscillating loop based on a separate feedback output electrode 607c for supplying a feedback output signal to the self-oscillating loop in accordance with a third embodiment of the invention. The piezoelectric power converter 600 shares a large number of electrical characteristics and features with the above described second embodiment of the power converter 400. Corresponding features have accordingly been provided with corresponding reference numerals to ease comparison. However, the way the feedback signal for the feedback leg 614 is derived from the piezoelectric transformer 604 differs between the present embodiment and the second embodiment discussed above. In the present embodiment, a separate feedback output electrode 607c supplies a feedback output signal Fb representative of the differential transformer output voltage across the first and second output electrodes 607a, 607b to the output voltage detection circuit 618. The first and second output electrodes 607a, 607b electrically coupled to respective secondary or output sections of the piezoelectric transformer 604 and the differential transformer output voltage is transmitted to a rectification circuit 608 in a manner similar to the second embodiment described above. The rectification circuit 608 may accordingly comprise a half or full wave rectifier coupled to an output capacitor(s) to provide a smoothed DC voltage at the output node or terminal V_{OUT}.

In the present embodiment, the piezoelectric transformer 604 is fabricated with the separate feedback output electrode 607c arranged or embedded in a separate layer of the output or secondary section of the piezoelectric transformer 604. The feedback signal supplied through the feedback path at the separate output electrode 607c is thereby galvanically isolated from the output sections or sides, output voltages such as V_{OUT} and electronic circuitry of the secondary side of the piezoelectric power converter 600. The skilled person will understand that the piezoelectric transformer 604 may comprise several separate feedback electrodes for example a dedicated feedback electrode in each of the output sections of the piezoelectric transformer 604 such that the illustrated feedback output signal Fb may comprise a differential feedback signal. A voltage gain, at the excitation frequency, from the input electrode 605 to the differential transformer signal across the first and second output electrodes 607a, 607b may be essentially equal to, larger than, or smaller than a voltage gain from the input electrode 605 to the feedback output electrode(s) 607c for example between 2 and 50 times larger or between 2 and 50 times smaller. In step-up or boost conversion applications of the present piezoelectric power converter 600, a smaller voltage gain to the feedback output electrode(s) 607c may be preferable such that galvanic isolation and an appropriate voltage level for electronic components of the output voltage detector 618 simultaneously are achieved. Even if the voltage gain, at the excitation frequency, from the input electrode 605 to the differential transformer signal across the first and second output electrodes 607a, 607b is essentially equal to the voltage gain from the input electrode 605 to the feedback output electrode(s) 607c, the piezoelectric power converter 600 benefits from the galvanic isolation between the input side and output side circuitry.

According to one such embodiment, a volume of the separate layer of the output section which encloses the feedback output electrode 607c is smaller than a volume of layers of the output section(s) enclosing the output electrodes 607a, 607b. This can be achieved by embedding the feedback output electrodes in a small portion of the secondary PT section, as it should occupy only a very small fraction of the output PT section (or input PT section if feedback is taken from the primary side). The feedback output electrodes will therefore not distort or degrade performance of the output section significantly. Depending on the specific piezoelectric transformer design and structure, embedding the feedback output electrode can be relatively straight-forward to implement. Embedding can also be very convenient if the voltage level of the output section is appropriate for electronic components of the output voltage detector 618, as the feedback output electrode 607c will possess a similar voltage level, if small parts of the existing electrodes in the output section are used, so the feedback output electrodes have the same layer thickness.

The feedback output electrode 607c can also be implemented as a separate section of the piezoelectric transformer 604 if this is more convenient, practical or the transformer design does not allow embedding the feedback output electrode. In any case, it is preferred that the separate feedback section of the piezoelectric transformer occupies a very small part of the entire piezoelectric transformer 604 structure without distorting or degrading the transformer performance as described above. Depending on the piezoelectric transformer design and structure, a separate output section may from a practical perspective be simpler to implement than embedding. The separate output section may also be more convenient for piezoelectric transformer designs where none of the output or secondary transformer sections has an appropriate voltage level for the electronic components of the output voltage detector 618.

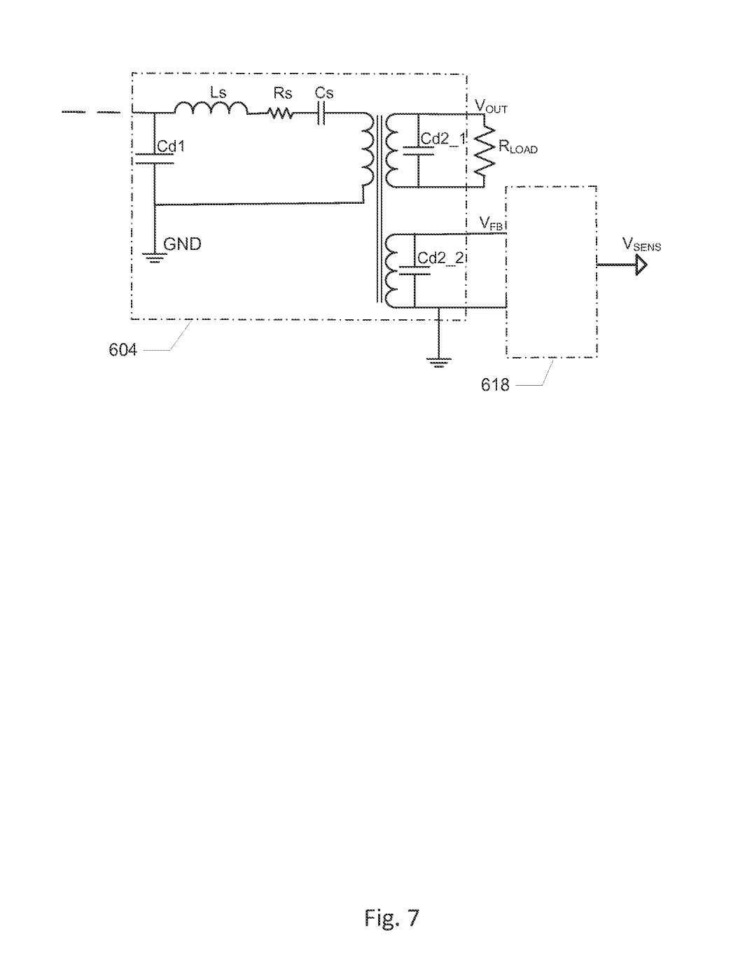

FIG. 7 illustrates a simplified electrical equivalent diagram inside dotted box 604 of the piezoelectric transformer 604 of the piezoelectric power converter 600 in accordance with the third embodiment of the invention. The simplified electrical equivalent diagram comprises a pair of separate secondary windings where the load is coupled to the upper secondary winding which also provides the positive DC output voltage V_{OUT}. The rectifier has been left out of the diagram for simplicity. The lower secondary winding corresponds to the separate feedback output electrode 607c and provides a feedback output signal V_{FB} to the output voltage detection circuit 618. As illustrated on the drawing, the lower secondary winding is galvanically isolated from the upper secondary winding and therefore not used to supply power to the load. Hence, the volume of the output section occupied by the separate feedback output electrode 607c can be much smaller than the volume of the output section(s) enclosing the output electrodes 607a, 607b.

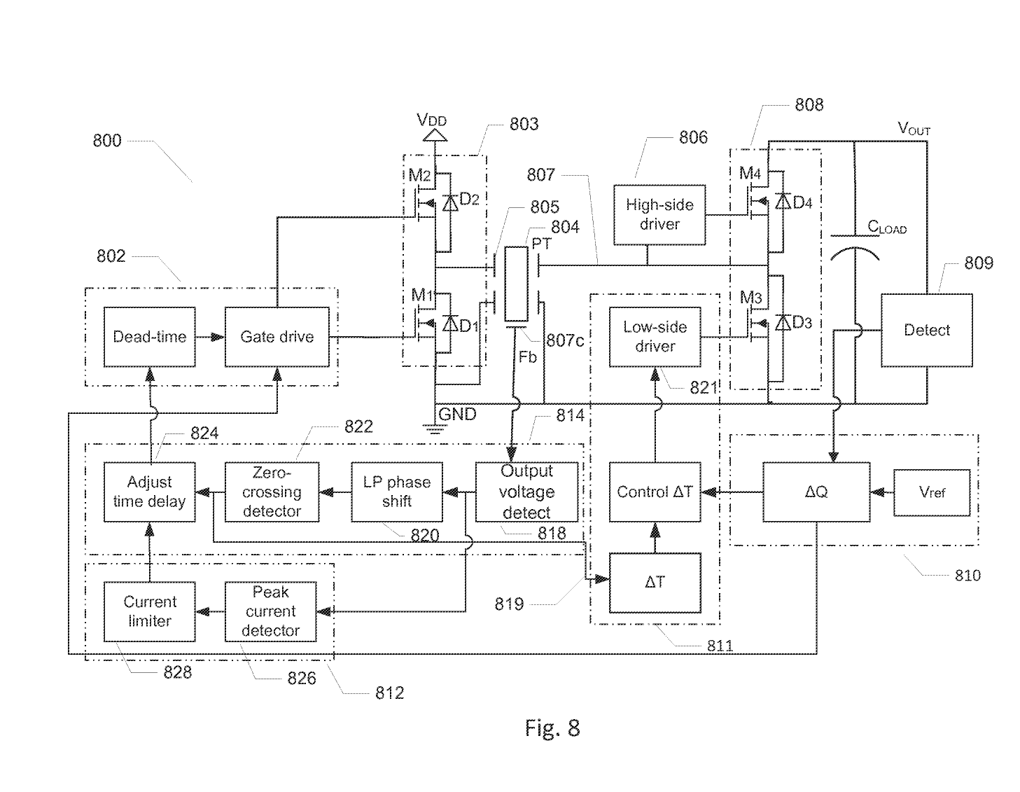

FIG. 8 is a schematic block diagram of a piezoelectric power converter 800 comprising a self-oscillating loop and a bi-directional switching circuit 808 for reverse power transfer in accordance with a fourth embodiment of the invention. The piezoelectric power converter 800 shares a large number of electrical characteristics and features with the above described third embodiment of the power converter 600, in particular a separate feedback output electrode 807c arranged or embedded in a separate layer of the output or secondary section of the piezoelectric transformer 804. The feedback signal from the feedback output electrode 807c is likewise supplied to the output voltage detection circuit 818 and further through a feedback path of the primary side such that the primary side circuitry becomes galvanic isolated from the secondary side.

At the secondary side of the PT 804, the bi-directional switching circuit 808 is electrically coupled between a single-ended transformer output signal generated at the output electrode 807 of the PT 804 and a positive DC output voltage V_{OUT} applied across a load capacitor C_{LOAD} of the power converter 800. The load may of course comprise a resistive and/or inductive component in addition to the depicted load capacitance C_{LOAD}. A controller or control circuit is adapted to control forward current conduction from the output electrode 807 to V_{OUT} through the bi-directional switching circuit 808 during a first period of the cycle time of the transformer output signal. The positive DC output voltage V_{OUT} is accordingly charged during the first period of the cycle time. This transformer output signal, oscillating at the excitation frequency set by the self-oscillating feedback loop around the feedback electrode 807c, is applied to a midpoint node between series coupled NMOS transistors M₄ and M₃ of the bi-directional switching circuit 808. The output section of the PT 804, oscillating at the excitation frequency, behaves largely as a current source injecting AC current into the midpoint node between series coupled M₄ and M₃ to generate the transformer output signal or voltage. Furthermore, the controller is adapted to control a second period of the cycle time of the transformer output signal wherein reverse current is conducted through the bi-directional switching circuit 808 to the output electrode 807 of the PT 804 such that V_{OUT} is discharged during the second period of the cycle time. During the second period of the cycle time power is returned to the primary section of the piezoelectric transformer through the output electrode 807 of the PT. The skilled person will appreciate that M₃ and M₄ function as respective controllable semiconductor switches each exhibiting low resistance between an inlet and an outlet node (i.e. drain and source terminals) in the on-state and very large resistance in the off-state or non-conducting state. The on-resistance of each of M₃ and M₄ in its on-state/conducting state may vary considerably according to requirements of a particular application, in particular the voltage level at the DC output voltage V_{OUT} or load impedance. In the present high-voltage embodiment of the invention, each of the M₃ and M₄ is preferably selected such that its on-resistance lies between 50 and 1000 ohm such as between 250 and 500 ohm. The positive DC supply voltage V_{DD} may vary widely in accordance with the requirements of a particular application. In the present embodiment of the invention, the positive DC supply voltage V_{DD} is preferably selected to a voltage between 20 and 40 volt such as about 24 volt.

The bi-directional switching circuit 808 comprises a high-side semiconductor diode D₄ arranged or coupled across drain and source terminals of M₄ so as to conduct the forward current to the DC output voltage V_{OUT} in a first state of the bi-directional switching circuit 808. A low-side semiconductor diode D₃ is in a similar manner coupled across drain and source terminals of M₃ so as to conduct the reverse current through the output electrode 807 and output section of the PT 804 during at least a portion of the first state. In the first state, the forward current is conducted from the output electrode 807 of the PT 804 through the bi-directional switching circuit 808 to the DC output voltage V_{OUT} during a first period of a cycle time of the transformer output signal to charge the output voltage. This is accomplished by switching the high-side NMOS transistor M₄ to its on-state or conducting state by a self-powered high-side driver 806 which forms part of the controller. The self-powered high-side driver 806 or self-powered driver 806 is coupled between the control or gate terminal of M₄ and the output electrode 807 which supplies the transformer output signal. The timing of the state switching of M₄ is determined by the detection of forward current in D₄ by a current sensor (not shown) contained in the self-powered driver 806. This current sensor is preferably arranged in series with the high-side semiconductor diode D₄. In response to detection of forward current in D₄ the self-powered driver 806 switches M₄ to its on-state which effectively clamps D₄ such that a majority of the forward current flowing through the parallel connection of M₄ and D₄ to the DC output voltage V_{OUT} in reality flows through M₄. On the other hand, during a negative half-cycle of the transformer output signal in the first state of the bi-directional switching circuit 808, D₄ is reverse biased and M₄ switched to its off-state at expiry of a timer period setting of an associated timer circuit (not shown). However, current is now conducted from the negative supply rail, i.e. GND in the present embodiment, to the output electrode 807 of the PT 804 through the parallel connection of M₃ and D₃. Initially, D₃ will start to conduct forward current once it becomes forward biased by the negative transformer output voltage. M₃ is on the other hand, switched to its on-state or conducting state by a low-side driver 821 which forms part of the controller. The low-side driver 821 is coupled to the gate terminal of M₃ and configured to switch M₃ from its off-state to its on-state and vice versa. However, while the timing of the state switching of M₃ from its off-state to the on-state is determined in a manner similar to M₄, the opposite state switching of M₃ is effected synchronously to input drive signal as explained below. M₃ is switched from the off-state to the on-state by a detection of forward current in D₃ by a current sensor (not shown) contained in the low-side driver 821. This current sensor is arranged in series with the low-side semiconductor diode D₃. At the detection of forward current in D₃ the low-side driver 821 switches M₃ to its on-state which effectively clamps D₃ such that a majority of the forward current flowing through the parallel connection of M₃ and D₃ in reality flows through M₃.

Consequently, in the first state the bi-directional switching circuit 808 functions as a half-wave rectifier or voltage doubler of the transformer output signal such that forward current is conducted from the output electrode 807 of the PT 804 through the high-side NMOS transistor M₄ and semiconductor diode D₄ to the DC output voltage V_{OUT} to charge V_{OUT}. In the negative half-periods of the transformer output signal, current is circulated around the secondary section of the PT 804 without charging the DC output voltage in the current embodiment which uses the half-wave rectification provided by the present bi-directional switching circuit 808. In comparison to a traditional diode-based half-wave rectifier, the bi-directional switching circuit 808 additionally comprises the NMOS transistors M₄ and M₃ of the bi-directional switching circuit 808 arranged for clamping of the high and low-side semiconductor diodes D₄ and D₃. During a second state and during a third state of the bi-directional switching circuit 808, the NMOS transistors M₃ and M₄ are controlled by the controller such that a flow of reverse power is enabled. Due to the inherent bi-directional transfer property of the PT 804 power applied to the secondary section through the output electrode 807 is transferred to the input section of the PT 804 in effect transferring power in opposite direction to the normal flow of power of the power converter 800.

In connection with the reverse current conduction during the second period of the cycle time, state switching of M₃ is controlled by the low-side driver 821 coupled to the gate terminal of M₃. The low-side driver 821 is responsive to a synchronous state control signal derived from the input drive signal supplied by an adjustable time delay circuit, control ΔT, of a phase controller 811. The phase controller comprises the adjustable time delay circuit, control ΔT, and a fixed time delay, ΔT circuit. The phase controller 811 receives s zero-crossing detector output signal 819 which switches states synchronously to the input drive signal and the transformer output signal because this signal is derived from the self-oscillating feedback loop. Since the input drive signal and the transformer output signal oscillate synchronously to each other, the time delay imposed by the phase controller 811 to the zero-crossing detector output signal 819 sets a length or duration of the second period of the cycle time of the transformer output signal. M₃ is allowed to continue conducting current for the duration of the second period of the cycle time until the state transition of the synchronous state control signal turns off M₃ of the low-side driver 821. While the corresponding state switching of the high-side NMOS transistor M₄ from its on-state to its off-state in one embodiment is controlled by the synchronous state control signal albeit phase shifted about 180 degrees, the present embodiment of the invention uses a different turn-off mechanism provided the self-powered high-side driver 806. The self-powering of the high-side driver 806 is configured to terminate a reverse current conducting period of M₄ based on an internally generated state control signal supplied by an internal timer rather than the above-described synchronous state control signal supplied by the adjustable time delay circuit, control ΔT. The self-powered property of the high-side driver 806 is highly advantageous for high-voltage output PT based power converters where the DC output voltage may be above 1 kV. The self-powering property of the high-side driver 806 circumvents the need for raising the zero-crossing detector output signal 819 to a very high voltage level, i.e. matching the level of the DC output voltage, before being supplied to the high-side driver 806 to appropriately control the gate terminal of M₄. The skilled person will recognize that the gate terminal of M₄ must be raised to a level above the level of the DC output voltage signal to switch M₄ to its on-state. The self-powered high-side driver 806 is electrically coupled between the gate terminal of M₄ and the output electrode 807 carrying the transformer output voltage. During operation, the bi-directional piezoelectric power converter 800 comprises two distinct mechanisms for adjusting the level of the DC output voltage V_{OUT}. A first mechanism uses a DC output voltage detection or monitoring circuit 809 which supplies a signal to the output voltage control circuit 810 of the controller indicating the instantaneous level of the DC output voltage. A charge control circuit ΔQ compares the instantaneous level of the DC output voltage with a reference voltage which for example represents a desired or target DC output voltage of the power converter. The charge control circuit determines whether the current DC output voltage is to be increased or decreased based on this comparison and adjusts at least one of: {a modulation of a pulse width modulated input drive signal, a carrier frequency of the pulse width modulated input drive signal, a burst frequency of a burst modulated input drive signal} in appropriate direction to obtain the desired adjustment of the DC output voltage. A second mechanism for adjusting the level of the DC output voltage V_{OUT} also uses the level signal from the DC output voltage detection circuit 809. In this instance the output voltage control circuit 810 adjusts the duration of the second period of the cycle time of the transformer output signal where M₃ conducts reverse current through the adjustable time delay circuit, control ΔT, of the phase controller 811. The corresponding adjustment of the second period of the cycle time as regards M₄ is preferably made by delaying the triggering time or point of the timer circuit included in the self-contained high-side driver 806. The delay of the triggering time of the timer circuit may be controlled dynamically during operation of the bi-directional power converter 800 by the controller by adjusting a delay of an adjustable time delay circuit, control ΔT, to reach a desired or target duration of the second period of the cycle time of the transformer output signal. The adjustable time delay circuit, control ΔT, allows the controller to adjust the duration of the second period of the cycle time of the transformer output signal wherein reverse current is conducted by the bi-directional switching circuit through the output electrode 807 back to the primary side of the PT 804. By this adjustment of the duration of the second period of the cycle time, the amount of generated reverse power can be effectively controlled allowing for the desired adjustment of the level of the DC output voltage V_{OUT} while conserving power.

The skilled person will appreciate that the degree of charge or discharge of the V_{OUT} may be controlled in a step-wise or substantially continuous manner by a corresponding control of the duration of the second period of the cycle time such that the level of V_{OUT} may be continuously increased or reduced as desired. The skilled person will understand that if the duration of the second period of the cycle time is set to zero by the controller, the bi-directional piezoelectric power converter 800 may be adapted to exclusively operate in the first state where the switching circuit charges the positive DC output voltage during the first period of cycle times of the transformer output signal. In this state, the NMOS transistors M₃ and M₄ are only conducting during the first period of the cycle time so to actively clamp the low-side and high-side semiconductor diodes D₃ and D₄, respectively.

The self-oscillating feedback loop comprising comprises a resonance current control circuit 812 comprising a peak current detector 826 coupled to a current limiter 828. The resonance current control circuit 812 is configured to adjust a time delay of the adjustable time delay circuit 824 arranged in the feedback leg 814. The resonance current level of the piezoelectric transformer 804 is determined based on the output signal of the output voltage detector 818, or, alternatively, from an output of a low-pass filter 820 coupled to the output voltage detector 818. The output voltage detector 818 may advantageously comprise a simple resistive load applied to the feedback signal from the feedback output electrode 807c. In this situation, the resonance current level of the piezoelectric transformer can be determined in a straightforward manner by the peak current detector 826 from the level of the feedback signal and the known resistance of the resistive load. The low-pass filter 820 may have similar electrical characteristics to the low-pass filter of the first embodiment discussed above. The zero-crossing detector 822 receives a low-pass filtered signal from the low-pass filter 820 and provides an essentially square wave shaped signal indicating zero-crossings of the filtered signal which possesses an approximate sine shaped waveform. The square wave signal is transmitted to an adjustable time delay circuit 824 which introduces a variable phase shift in the self-oscillating feedback loop such that the predetermined excitation frequency can be adjusted. An output signal of the adjustable time delay circuit 824 is coupled to the drive control circuit 802 such as to close the self-oscillating feedback loop around an input driver 803. A resonance current control circuit 812 detects a peak current from the output signal of the output signal of the voltage detector 818 as described above and adjusts a time delay of the adjustable time delay circuit 824 based thereon. This is useful to compensate for an increase of ac resonance current under reverse power transmission through the piezoelectric power converter, e.g. in the second state of the bi-directional switching circuit 808. The ac resonance current in the piezoelectric transformer increases under reverse power transmission and this condition is detected by the peak current detector 826 of the resonance current control circuit 812. The effect is compensated by limiting the ac resonance current by the current limiter 828 which makes an appropriate adjustment of the time delay in the adjustable time delay circuit 824 such that an optimal operation point of the self-oscillating feedback loop can be maintained during both forward power transmission and reverse power transmission of the bi-directional piezoelectric power converter 800. In the present embodiment of the invention where the input driver 803 is coupled directly to the input electrode 805 without any series or parallel inductor, the piezoelectric transformer 104 preferably possess a ZVS factor larger than 100% such as larger than 120%. In this manner ZVS operation of the input driver 103 is enabled both in a first state and a second state of a bi-directional switching circuit 808. The ZVS operation of the input driver 103 improves the power conversion efficiency of the bi-directional piezoelectric power converter 800. The predetermined excitation frequency is preferably selected in the manner already discussed above in connection with the first embodiment of the invention. The use of the self-oscillating feedback loop has considerable advantages because, the predetermined excitation frequency automatically tracks changing characteristics of the piezoelectric transformer 804 and electronic circuitry of the input side of the power converter like the drive control circuit 802. These characteristics will typically change across operation temperature and age but the self-oscillating feedback loop ensures changes are tracked by the excitation frequency because a slope of the phase response of the piezoelectric transformer 804 is typically much steeper than a slope of a phase response of the low-pass filter 820. In this manner, the predetermined excitation frequency will be significantly more sensitive to changes in frequency response characteristic of the piezoelectric transformer 804 such that the self-oscillating feedback loop automatically maintains the predetermined excitation frequency at an optimum frequency or within an optimum frequency band such as in the ZVS operation band of the piezoelectric transformer 804.

1. A piezoelectric power converter comprising:
a piezoelectric transformer comprising an input electrode electrically coupled to an input or primary section of the piezoelectric transformer and an output electrode electrically coupled to secondary or output section of the piezoelectric transformer to provide a transformer output voltage,
an input driver electrically coupled directly to the input electrode without any intervening series or parallel inductor to supply an input drive signal to the input electrode,
a feedback loop operatively coupled between the output voltage of the piezoelectric transformer and the input driver to provide a self-oscillation loop around the primary section of the piezoelectric transformer, oscillating at an excitation frequency, wherein:
electrical characteristics of the feedback loop are configured to set the excitation frequency of the self-oscillation loop within a ZVS operation range of the piezoelectric transformer.

2. A piezoelectric power converter according to claim 1, wherein a feedback signal of the feedback loop is derived from the transformer output signal at the output electrode of the piezoelectric transformer.

3. A piezoelectric power converter according to claim 1, wherein a feedback signal of the feedback loop is derived from a feedback output signal at a feedback output electrode arranged in one or more separate layer(s) of the output section of the piezoelectric transformer to galvanically isolate the feedback output electrode from the output electrode.

4. A piezoelectric power converter according to claim 4, wherein a volume of the separate layer(s) of the output section enclosing the feedback output electrode is smaller than a volume of layers of the output section enclosing the output electrode.

5. A piezoelectric power converter according to claim 3, wherein a voltage gain, at the excitation frequency, from the input electrode to the output electrode is larger or smaller than a voltage gain from the input electrode to the feedback output electrode, preferably between 2 and 50 times larger or between 2 and 50 times smaller.

6. A piezoelectric power converter according to claim 1, wherein a feedback signal of the feedback loop is derived by a transformer resonance current estimator from a combination of the input drive signal and a transformer input current running in the primary section of the piezoelectric transformer.

7. A piezoelectric power converter according to claim 6, wherein the resonance current estimator comprises:
a first order differentiator coupled to the input drive signal to derive a first order derivative signal of the input drive signal,
a current sensor, coupled in series with the primary section of the piezoelectric transformer, to supply a sensor signal representative of the transformer input current; and
a subtractor configured to generate the feedback signal based on a difference between the first order derivative signal and the sensor signal.

8. A piezoelectric power converter according to claim 6, wherein the first order differentiator comprises a first order high-pass filter having an input coupled to the input drive signal and an output supplying the first order derivative signal;
wherein a high-pass corner frequency of the first order high-pass filter is larger than a fundamental resonance frequency of the piezoelectric transformer such as at least two times larger or preferably more than 10 times larger.

9. A piezoelectric power converter according to claim 6, wherein the subtractor comprises a differential amplifier having a first differential input coupled to the first order derivative signal and the second differential input coupled to the sensor signal.

10. A piezoelectric power converter according to claim 5, wherein the input current sensor comprises a resistance arranged in-between a ground connection of the input driver and a ground connection of the piezoelectric transformer.

11. A piezoelectric power converter according to claim 2, wherein the feedback loop comprises a cascade of:
a phase shifter coupled for receipt of the feedback signal to apply a predetermined phase shift to the feedback signal to provide a phase shifted feedback signal,
a comparator coupled for receipt of the phase shifted feedback signal to generate a square-wave feedback signal at a comparator output; wherein the square-wave feedback signal is coupled to an input of the input driver so as to close the feedback loop.

12. A piezoelectric power converter according to claim 11, wherein the phase shifter comprises a high-pass, band-pass, low-pass filter or a time delay.

13. A piezoelectric power converter according to claim 10, wherein the comparator comprises an inverting zero-crossing detector to provide square-wave feedback signal indicating zero-crossings of the phase-shifted feedback signal.

14. A piezoelectric power converter according to claim 1, further comprising:
a bi-directional switching circuit coupled between the output electrode and an output voltage of the power converter,
a controller adapted to control first and second states of the bi-directional switching circuit based on the input drive signal or the transformer output voltage such that:
in a first state, forward current is conducted from the output electrode to the output voltage through the bi-directional switching circuit during a first period of a cycle time of the transformer output signal to charge the output voltage,
in a second state, reverse current is conducted from the output voltage to the output electrode through the bi-directional switching circuit during a second period of the cycle time of the transformer output signal to discharge the output voltage and return power to the primary section of the piezoelectric transformer.

15. A piezoelectric power converter according to claim 14, wherein the controller in the second state is further configured to control the switching circuit such that:
both forward current and reverse current is conducted during a single cycle of the transformer output signal.

16. A piezoelectric power converter according to claim 14, wherein the switching circuit comprises a half-wave rectifier or a full-wave rectifier operatively coupled to the output electrode.

17. A piezoelectric power converter according to claim 14, wherein the feedback loop comprises an adjustable time delay coupled in cascade with the phase shifter and the comparator to adjust the excitation frequency of the self-oscillating loop.

18. A piezoelectric power converter according to claim 17, wherein the feedback loop comprises:
a current detector configured to determine a level of a transformer resonance current resonance of the piezoelectric transformer,
a current limiter adapted to adjust a time delay of the adjustable time delay circuit to limit the transformer resonance current.

19. A piezoelectric power converter according to claim 1, wherein a slope or derivative of a phase response of a transfer function of the piezoelectric transformer is steeper than slope or derivative of a phase response of the band-pass, high-pass or low-pass filter within the ZVS operation range of the piezoelectric transformer.

20. A piezoelectric transformer according to claim 1, comprising a piezoelectric transformer with a zero-voltage switching factor (ZVS factor) larger than 100%, or larger than 120%, or larger than 150% or 200%;
in which the ZVS factor is determined at a matched load condition as:
$$Z V S = \frac{( {k}_{eff\_S}^{- 2} ) - 1}{( {k}_{effP}^{- 2} ) - 1} 0.662 ;$$
k_{eff}_{_{—}}_{P}, being a primary side effective electromechanical coupling factor of the piezoelectric transformer,
k_{eff}_{_{—}}_{S}, being a secondary piezoelectric transformer effective electromechanical coupling factor, in which:
$${k}_{eff\_S} = \sqrt{1 - \frac{{f}_{res\_S}^{2}}{{f}_{anti - res , p}^{2}}}$$
$${k}_{eff\_s} = \sqrt{1 - \frac{{f}_{res\_s}}{{f}_{anti \text{-} ress}^{2}}}$$
fᵣₑₛ_{_{—}}ₚ=resonance frequency and frequency of a minimum magnitude of an impedance function at the input electrodes of the piezoelectric transformer with shorted output electrodes,
fₐₙₜᵢ₋ᵣₑₛ_{_{—}}ₚ=anti-resonance frequency and frequency of a maximum magnitude of the impedance function at the input electrodes of the piezoelectric transformer with shorted output electrodes,
fᵣₑₛ_{_{—}}ₛ=resonance frequency and frequency of a minimum magnitude of the impedance function at the output electrodes of the piezoelectric transformer with shorted input electrodes,
fₐₙₜᵢ₋ᵣₑₛ_{_{—}}ₛ=anti-resonance frequency and frequency of a maximum magnitude of the impedance function at the output electrodes of the piezoelectric transformer with shorted input electrodes.

21. A piezoelectric power converter according to claim 1, wherein a bandwidth of the ZVS operation range of the piezoelectric transformer lies between 1% and 5% of a fundamental or primary resonance frequency of the piezoelectric transformer.

22. A piezoelectric power converter according to claim 1, wherein a wiring inductance at the output of the input driver to the input electrode is smaller than 500 μH, or smaller than 100 μH, or smaller than 10 μH.

23. A piezoelectric power converter according to claim 1, comprising a start-up circuit configured to inject a transient signal into the feedback loop at power-up of the power converter to initiate oscillation at the excitation frequency in the feedback loop.

24. A piezoelectric power converter according to claim 23, wherein the start-up circuit comprises an oscillator coupled into the feedback loop.
